(19) United States
(12) Patent Application Publication
(10) Pub. No.: US 2001/0033228 A1
(43) Pub. Date: Oct. 25, 2001

(54) Novel smart holster

(76) Inventors: Boaz Kisreman, Kidron (IL); Moshe Einat, Ashdod (IL)

Correspondence Address: D'VORAH GRAESER, C/O THE POLKINGHORNS, 9003 FLORIN WAY, UPPER MARLBORO, MD, 20772, US

(21) Appl. No.: 09/860,500

(22) Filed: May 21, 2001

Related U.S. Application Data
(63) Continuation-in-part of application No. 09/101,994, filed on Jul. 15, 1998.

(30) Foreign Application Priority Data
Jan. 16, 1997 (IL) 116801
Jan. 16, 1997 (IL) PCT/IL97/00024

(51) Int. Cl. G08B 29/00

(52) U.S. Cl. 340/568.1; 340/5.7; 340/5.73; 42/70.01; 340/539

(57) ABSTRACT

A novel smart holster for retaining firearms, facilitating substantially immediate uninhibited access to qualified and authorized personnel, thereby preventing removal of the firearm by an unauthorized individual and geared towards aiding in any weapon retention technique including a holster and wireless remote unit. It is understood that the terns “receiver” and “transmitter” are used for the sake of clarity, in order to indicate whether a particular component resides on the wireless remote unit (“transmitter”) or on the holster (“receiver”), as preferably both the remote unit and the holster feature a transceiver. The holster may optionally be incorporated with a mechanical lock and remote unit, which can either be installed as a complete system, or retrofitted on existing holsters with minimal modification.

### CROSS REFERENCE TO RELATED APPLICATIONS

The subject application is a Continuation-in-Part Application of U.S. patent application Ser. No. 09/101,994, filed on Jul. 15, 1998, which is currently pending and which is incorporated by reference as if fully set forth herein.

### FIELD AND BACKGROUND OF THE INVENTION

The present invention relates to security of firearms and, in particular, it concerns a security lock for firearm storage, which selectively releases the firearm to an authorized user.

Law enforcement officers and other security personnel are often exposed to considerable risk that a firearm may be misappropriated and used against them. The risk is particularly acute in the case of handguns carried in a holster during riots or other supervision of antagonistic individuals or crowds at close quarters.

A plurality of weapon retention techniques have been developed by many Law Enforcement Trainers (LET's), which implement hand-to-hand combat and martial arts techniques.

Furthermore, many manufacturers have attempted to create varying degrees of security mechanisms incorporated into the holster design. Current nomenclature refers to such holsters as Level I, Level II and Level III safety holsters. Characteristically, Level I safety holsters generally require manipulation of a single retentive mechanism such as a thumb strap. Level II holsters usually require a sequential two-step action to draw a weapon from the holster such as opening a thumb snap and thereafter raking the weapon at a predetermined angle to clear the handgun from the holster.

Presently, Level III holsters are considered as the most retentive holster style. A latent deficiency of such holsters is their robust cumbersome construction and difficulty of manipulation.

For an Officer to “present” a firearm, the officer usually has to perform the following a complicated manual of arms under an immediate and otherwise unavoidable risk of death or great bodily harm.

By way of example, most Level III holsters require a thumb snap to be opened prior to a lower trigger-finger snap being opened and followed by an awkward forward and backward displacement of the firearm prior to clearing the weapon from the holster.

The difficulty in drawing a firearm from such a holster is exacerbated when individuals of a relatively smaller physique attempt to draw a firearm from a class III holster. It is not uncommon for such individuals to “miss” the manipulation of the trigger-finger snap, resulting in failure to present the firearm.

It is manifestly clear that complex motor skills under extreme stress situations have led to many officers loosing their lives.

It is, of course, known to provide secure storage for firearms and other weapons. Typically, such storage entails locking die firearm within a cabinet, or otherwise securing it by use of a padlock. However, such techniques cannot be used in a situation in which instant access to the firearms is required.

There is therefore a need for a smart holster for retaining firearms, facilitating substantially immediate uninhibited access to qualified and authorized personnel, thereby preventing removal of the firearm by an unautliorized individual and geared towards aiding in any weapon retention technique.

### SUMMARY OF THE INVENTION

The present invention is a smart holster for retaining firearms, facilitating substantially immediate uninhibited access to qualified and authorized personnel, thereby preventing removal of the firearm by an unauthorized individual and geared towards aiding in any weapon retention technique.

The smart holster optionally incorporates an electromechanical device, either incorporated with a mechanical lock or alternatively embodied as an electrical lock, which is controlled through a wireless device such as a ring with a transmitter, for example. The resulting electromechanical lock is preferably fitted with a set of one or more “smart” features, such as being able to identify an authorized user, determine, communicate, monitor and/or alter the state of the lock through the wireless device, for example. The system of the present invention preferably enables the smart feature(s) and the wireless device control to be incorporated into an existing holster.

According to the teachings of die present invention there is provided, a smart holster lock system for facilitating access to qualified and authorized personnel and thereby preventing removal of the firearm by an unauthorized individual, including: a wireless communication unit communicating with a remote unit a locking unit for securing a firearm in the holster and the locking unit being responsive to being activated by the wireless communication unit, and an identification unit electrically attached to the communication unit for identifying authorized remote units.

According to yet further teachings of tie present invention there is provided, a smart holster system, including: a holster including: a remote wireless receiver for receiving an instruction; a locking unit module for being activated by the wireless transceiver upon receipt of the instruction; and an identification unit for identifying user authorized to remove a firearm from the holster, and a wireless remote unit for controlling the locking unit, the remote unit including a wireless transmitter for transmitting the instruction to the wireless receiver.

Hereinafter, the term “wireless device” refers to any device, which is capable of transmitting a signal to a receiver, which is not electronically or electrically wired to the wireless device. A preferred example of a wireless device is a transmitter in a ring worn on the hand of a user.

Hereinafter, the term “mechanical lock” refers to a firearm securing mechanism, which contains only mechanical (physical) components, such as any mechanical mechanism geared towards securing a firearm in a holster.

Hereinafter, the term “electrical lock” refers to a firearm securing mechanism, which is operated through electrical components, such as electrically charged magnets or any electrical mechanism geared towards securing a firearm in a holster.

Hereinafter, the term “electromechanical lock” refers to a firearm securing mechanism, which combines these electrical and mechanical components.

### BRIEF DESCRIPTION OF THE DRAWINGS

The invention is herein described, by way of example only, with reference to the accompanying drawings, wherein:

FIG. 1 is a schematic diagram view of the smart holster according to the present invention, and

FIG. 2 is a side view of the smart holster according to the present invention.

### DESCRIPTION OF THE PREFERRED EMBODIMENTS

The present invention is a novel smart holster for retaining firearms, facilitating substantially immediate uninhibited access to qualified and authorized personnel, thereby preventing removal of the firearm by an unauthorized individual and geared towards aiding in any weapon retention technique.

The principles and operation of a smart holster for retaining firearms, facilitating substantially immediate uninhibited access to qualified and authorized personnel, according to the present invention may be better understood with reference to the drawings and the accompanying description.

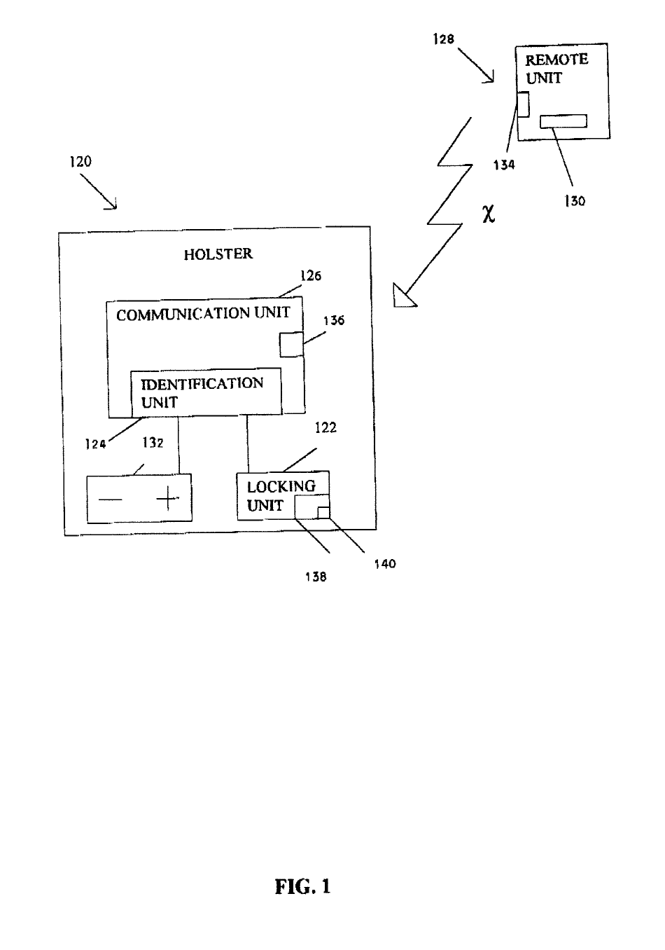

FIG. 1 is a schematic diagram of the smart holster according to the present invention. FIG. 1 shows a holster 120 including a locking unit 122 for securing firearms.

For the purpose of readily securing and releasing firearms from holster 120, an identification unit 124 is electronically attached to locking unit 122 for identifying authorized users and facilitating substantially immediate uninhibited access to qualified and authorized personnel, thereby preventing unauthorized insertion and removal of firearms from holster 120 by an unauthorized individual.

Identification unit 124 is electronically attached to a wireless communication unit 126 such that wireless communication unit 126 can readily communicate with a remote unit 128.

Preferably, remote unit 128 includes a coding module 130 for creating unique codes to a multiplicity of remote units 128. Thus, authorized access is limited to those individuals authorized subsequently to wireless communication unit 126 identifying authorized coding modules 130.

Due to many law enforcement agencies requiring weapon qualification prior to officers being allowed to carry and use certain classes of weapons, a plurality of coding modules can be used to create a class of users. For example, Sergeants in a police department or military unit may be qualified to use handguns, sub-machineguns and shotguns whole corporals may be qualified to carry and use handguns only.

Thus, all sergeants carrying remote units 128 will have access to all handguns, sub-machineguns and shotguns in the department or unit. Similarly, all corporals carrying remote units 128 will have access to all handguns in the unit but not to sub-machineguns and shotguns.

Preferably, wireless communication unit 126 is programmed to identify remote unit 128 and open locking unit 122 when remote unit 128 is brought within a predetermined distance of holster 120.

More preferably, remote unit 128 is attached to, or integrally formed with a ring worn on the authorized user's hand (not sown in FIG. 1).

Especially preferred, wireless communication unit 126 differentiates between proximity of remote unit 128 consistent with drawing a firearm from holster 120 and proximity or remote unit 128, which is inconsistent with drawing a firearm from holster 120. For example, during an ensuing weapon retention struggle, the hands of the authorized user may be brought proximally to holster 120 for the purpose of implementing a variety of weapon retention techniques but without the user intending to unlock locking unit 122.

Preferably, remote unit 128 and identification unit 124 can be readily programmed to create any class of authorized having substantially immediate uninhibited access to firearms in holster 120.

Law Enforcement departments often assign an experienced officer to a rookie as a Training Officer (TO's”). Preferably, remote unit 128 carried by a TO would facilitate access to both the TO's firearms and the rookie's firearms while remote unit 128 carried by the rookie will only facilitate access to the rookie's firearms.

Creating classes of authorized users substantially prevents wrongful accusations being brought against officers that officers used a firearm they were not qualified to use.

Preferably, holster 120 is constructed substantially of plastic, nylon or Kydex®. Thus, occasioning on a perpetrator attempting to disarm an officer, the officer can perform any weapon retention technique while the firearm is secured in holster 120. Such a construction will also be effective against modern disarming techniques, whereby all individual holds the firearm or holster 120 and abruptly drops downwards in an attempt to shear holster 120 from the officer's belt.

Due to the holster 120 being substantially rigid in construction and the firearm is secured by locking unit 122, even if a perpetrator succeeds in shearing holster 120 from the gun-belt, the firearm is secure in holster 120 and cannot be fired by the perpetrator. Occasioning on an officer carrying a backup firearm, the officer can then use the backup firearm to incapacitate the perpetrator.

Typically, power is supplied to some, or all, components of holster 120 from a battery power source 132. Battery power source 132 may be of any conventional battery design or combination thereof, and either disposable or rechargeable. Additionally, or alternatively, an external battery pack (not shown in FIG. 1) may be provided to allow highly extended periods of continuous use without requiring battery replacement or recharging.

Preferably, a hand-mounted transmitter unit 134 for transmitting codes from coding module 130 is included in remote unit 128.

Transmitter unit 134 transmits identification codes to a receiver and processor unit 136 included in wireless communication unit 126, along a path generally designated “χ” FIG. 1.

When transmitter unit 134 is brought sufficiently close to holster 120, receiver and processor unit 136 receives and processes the transmitted signal to identify the code originating from coding module 130. Once the signal is identified, receiver and processor unit 136 actuates unlocking of locking unit 122 from a locked state in which it secures the firearm in holster 120 to an unlocked state in which locking unit 122 facilitates substantially immediate uninhibited access to the firearm in holster 120.

In use, locking unit 122 is generally operative to lock firearm 12 within holster 120, thereby preventing an unauthorized party from disarming the user. However, when the authorized user reaches toward holster 120 to draw the firearm from holster 120, hand-mounted transmitter 134 is brought into proximity with receiver and processor unit 136, thereby allowing identification of the characteristic transmitted signal and subsequent unlocking of locking unit 122 and facilitating authorized access to the firearm.

Thus, smart holster 120 achieves a high weapon retention level of against unauthorized removal of a firearm from holster 120 while allowing instant access to the authorized user and substantially eliminating the risk of “fumbling” commonly encountered by level III holsters.

Typically, when the firearm is not accommodated by holster 120, locking unit 122 in its unlocked state for a predetermined period, or until a firearm is inserted into holster 120.

Preferably, locking unit 120 includes a firearm detector 138 for detecting an insertion of a firearm into holster 120 for substantially immediate locking of locking unit 120 to secure the firearm.

Preferably, occasioning on a partial draw or unlocking of locking unit 120 without drawing the firearm, firearm detector 138 detects that unlocking mechanism is unlocked and the firearm is accommodated by holster 120, substantially immediately thereafter, locking unit 120 locks the firearm in holster 120.

Preferably, firearm detector 138 includes a micro-switch 140 readily operated by the muzzle or trigger guard of a firearm being inserted into holster 120.

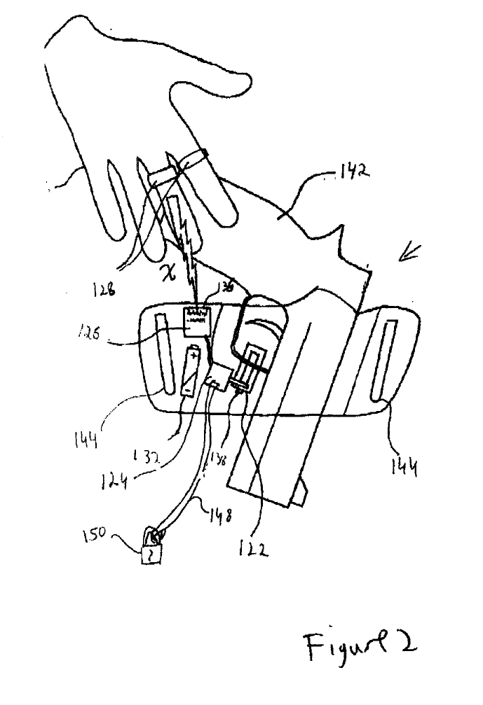

FIG. 2 shows the smart holster components shown in FIG. 1 in an especially preferred embodiment of holster 120.

Holster 120 shown is of a belt slide configuration with at least one belt loop 144, however the smart holster of the present invention can be readily manufactured and incorporated in any holster configuration, regardless whether holster 120 is a security holster, duty holster or an inside the waistband (IWB).

Like above, for the purpose of readily securing and releasing a firearm 142 from holster 120, a locking unit secures firearm 142 in holster 120. An identification unit 124 is electronically attached to locking unit 122 for identifying authorized users and facilitating substantially immediate uninhibited access to qualified and authorized personnel, thereby preventing unauthorized insertion and removal of firearm 142 from holster 120 by an unauthorized individual.

Here as well, identification unit 124 is electronically attached to a wireless communication unit 126 such that wireless communication unit 126 can readily communicate with a remote unit 128.

Preferably, remote unit 128 includes a coding module (not shown in FIG. 2) for creating unique codes to a multiplicity of remote units 128. Thus, authorized access is limited to those individuals authorized subsequently to wireless communication unit 126 identifying authorized coding modules.

Preferably, wireless communication unit 126 is programmed to identify remote unit 128 and open locking unit 122 when remote unit 128 is brought within a predetermined distance of holster 120.

More preferably, remote unit 128 is attached to, or integrally formed with a ring 128 worn on an authorized user's hand 146.

Especially preferred, at least one ring 128 is worn on the trigger finger of the user for enhanced reliability of differentiating between an actual firearm draw and proximity of ring 128 when the user does not intend to draw the firearm 142.

Especially preferred, wireless communication unit 126 differentiates between proximity of ring 128 consistent with drawing firearm 142 from holster 120 and proximity or ring 128, which is inconsistent with drawing firearm 142 from holster 120. For example, during an ensuing weapon retention struggle, hands 146 of the authorized user may be brought proximally to holster 120 for the purpose of implementing a variety of weapon retention techniques but without the user intending to unlock locking unit 122.

Preferably, ring 128 and identification unit 124 can be readily programmed to create any class of authorized having substantially immediate uninhibited access to firearm 142 in holster 120.

Law Enforcement departments often assign an experienced officer to a rookie as a Training Officer (TO's”). Preferably, ring 128 carried by a TO would facilitate access to both the TO's firearm 142 and the rookie's firearm 142 while ring 128 carried by the rookie will only facilitate access to the rookie's firearm 142.

Creating classes of authorized users substantially prevents wrongful accusations being brought against officers that officers used a firearm they were not qualified to use.

Preferably, holster 120 is constructed substantially of plastic, nylon or Kydex®. Thus, occasioning on a perpetrator attempting to disarm an officer, the officer can perform any weapon retention technique while firearm 142 is secured in holster 120. Such a construction will also be effective against modem disarming techniques, whereby an individual holds firearm 142 or holster 120 and abruptly drops downwards in an attempt to shear holster 120 from the officer's belt.

Due to the holster 120 being substantially rigid in construction and firearm 142 is secured by locking unit 122, even if a perpetrator succeeds in shearing holster 120 from tie gun-belt, firearm 142 is secure in holster 120 and cannot be fired by the perpetrator. Occasioning on an officer carrying a backup firearm, the officer can then use the backup firearm to incapacitate the perpetrator.

Typically, power is supplied to some, or all, components of holster 120 from arm battery power source 132. Battery power source 132 may be of any conventional battery design or combination thereof, and either disposable or rechargeable. Additionally, or alternatively, an external battery pack (not shown in FIG. 1) may be provided to allow highly extended periods of continuous use without requiring battery replacement or recharging.

Like above, ring 128 transmits identification codes to a receiver and processor unit 136 included in wireless communication unit 126, along a path generally designated “χ” in FIG. 2.

When ring 128 is brought sufficiently close to holster 120, receiver and processor unit 136 receives and processes the transmitted signal to identify die authorization code originating from ring 128. Once the signal is identified, receiver and processor unit 136 actuates unlocking of locking unit 122 from a locked state in which it secures firearm 142 in holster 120 to an unlocked state in which locking unit 122 facilitates substantially immediate uninhibited access to firearm 142 in holster 120.

In use, locking unit 122 is generally operative to lock firearm 142 within holster 120, thereby preventing an unauthorized party from disarming the user. However, when die authorized user reaches toward bolster 120 to draw firearm 142 from holster 120, ring 128 is brought into proximity with receiver and processor unit 136, thereby allowing identification of the characteristic transmitted signal and subsequent unlocking of locking unit 122 and facilitating authorized access to firearm 142.

Thus, smart holster 120 achieves a high weapon retention level of against unauthorized removal of firearm 142 from holster 120 while allowing instant access to tie authorized user and substantially eliminating the risk of “fumbling” commonly encountered by Level III holsters.

Typically, when firearm 142 is not accommodated by holster 120, locking unit 122 in its unlocked state for a predetermined period, or until firearm 142 is inserted into holster 120.

Preferably, locking unit 120 includes a firearm detector 138 for detecting an insertion of firearm 142 into holster 120 for substantially immediate locking of locking unit 120 to secure firearm 142.

Preferably, occasioning on a partial draw or unlocking of locking unit 120 without drawing firearm 142, firearm detector 138 detects that unlocking mechanism is unlocked and firearm 142 is accommodated by holster 120, substantially immediately thereafter, locking unit 120 locks firearm 142 in holster 120.

Preferably, firearm detector 138 includes a micro-switch 140 readily operated by the muzzle or trigger guard of firearm 142 being inserted into holster 120.

Preferably, a cable 148 is attached to locking unit such that when locking unit 122 is unlocked, cable 148 can be readily removed from locking unit 122, Conversely, when locking unit 122 is locked, cable 148 can is secured and cannot be removed from locking unit 122. Thus, a single operation of opening locking unit 126 also releases cable 148, thereby facilitating rapid deployment of users, when required. Furthermore, users can attach holster 120 to fixed items such as desks preventing theft of firearm 142.

It is common for police officers returning to their desk to secure their handguns in their desk. Thus, securing firearm 142 to an officer's desk is readily performed.

Preferably, cable 148 is also attached to a lock 150 for securing holster 120 to a fixed object such as a desk.

Although the present invention has been described in terms of handguns and firearms, it will be appreciated that the present invention may be used with any firearm, rifle, sub-machinegun, shotgun, sniper-rifle, pistols, revolvers and handguns.

It will be appreciated that the above descriptions are intended only to serve as examples, and that many other embodiments are possible within the spirit and the scope of the present invention.

What is claimed is:

1. A smart holster lock system for facilitating access to qualified and authorized personnel and thereby preventing removal of the firearm by an unauthorized individual, including:
(a) a wireless communication unit communicating with a remote unit;
(b) a locking unit for securing a firearm in said holster and said locking unit being responsive to being activated by said wireless communication unit; and
(c) an identification unit electrically attached to said communication unit for identifying authorized remote units.

2. The smart holster of claim 1, further including a coding module attached to said remote unit for identifying authorized users of said holster.

3. The smart holster of claim 2, wherein said remote unit is a ring worn by a user.

4. The smart holster of claim 3, further including a firearm detector for detecting an insertion of a firearm into said holster.

5. The smart holster of claim 4, further including a micro-switch readily operated by the muzzle or trigger guard of a firearm being inserted into said holster.

6. The smart holster of claim 5, further including a cable attached to said locking for securing said holster to a fixed location.

7. The smart holster of claim 6, wherein said locking unit unlocks and releases said cable occasioning on said ring being proximate to said holster.

8. The smart holster of claim 7, wherein said locking unit identification unit, communication unit and remote unit are readily retrofitted to any existing holster.

9. A smart holster system, including:
(a) a holster including:
(i) a remote wireless receiver for receiving an instruction;
(ii) a locking unit module for being activated by said wireless transceiver upon receipt of said instruction; and
(iii) an identification unit for identifying user authorized to remove a firearm from said holster; and
(b) a wireless remote unit for controlling said locking unit, said remote unit including a wireless transmitter for transmitting said instruction to said wireless receiver.

10. The smart holster of claim 9, further including a coding module attached to said remote unit for identifying authorized users of said holster.

11. The smart holster of claim 10, wherein said remote unit is a ring worn by a user.

12. The smart holster of claim 11, further including a firearm detector for detecting an insertion of a firearm into said holster.

13. The smart holster of claim 13, further including a micro-switch readily operated by the muzzle or trigger guard of a firearm being inserted into said holster.

14. The smart holster of claim 13, further including a cable attached to said locking for securing said holster to a fixed location.

15. The smart holster of claim 14, wherein said locking unit unlocks and releases said cable occasioning on said ring being proximate to said holster.

16. The smart holster of claim 15, wherein said locking unit, identification unit, communication unit and remote unit are readily retrofitted to any existing holster.
